(19) United States
(12) Patent Application Publication
(10) Pub. No.: US 2013/0179543 A1
(43) Pub. Date: Jul. 11, 2013

(54) Method of providing online sporting event services

(71) Applicant: Feng-An Yu, Taichung (TW)

(72) Inventor: Feng-An Yu, Taichung (TW)

(21) Appl. No.: 13/594,889

(22) Filed: Aug. 27, 2012

(30) Foreign Application Priority Data
Jan. 6, 2012 (TW) 101100553

(51) Int. Cl. G06F 15/16

(52) U.S. Cl. 709/219

(57) ABSTRACT

A method of providing online sporting event services includes providing a sports portal including a sporting event registration module so that each of a plurality of members is allowed to file with the sporting event registration module by loading data including bibliographical data into the sporting event registration module for storage; providing a transmitter and a verification code to each member wherein the verification code is unique to the transmitter; electrically connecting a receiver to the sports portal wherein the receiver receives signals transmitted from the transmitter; causing the sports portal to verify the verification code by comparing the verification code with data stored in the sporting event registration module; finishing a registration if the verification is positive; and sending the registration to the sports portal.

### BACKGROUND OF THE INVENTION

1. Field of the Invention

The invention relates to sporting event and more particularly to a method of providing online sporting event services.

2. Description of Related Art

The Internet is a global system of interconnected computer networks that use the standard Internet protocol suite (e.g., TCP/IP) to serve billions of users worldwide. It is a network of networks that consists of millions of private, public, academic, business, and government networks, of local to global scope, that are linked by a broad array of electronic, wireless, and optical networking technologies. The Internet carries an extensive range of information resources and services.

The Internet has enabled and accelerated new forms of human interactions through instant messaging, Internet forums, and social networking. Online shopping has boomed both for major retail outlets and small artisans and traders.

Regarding sports programming and others, ESPN should be mentioned. ESPN is an American global cable television network focusing on sports-related programming including live and pre-taped event telecasts, sports talk shows, and other original programming.

Typically, information about registration of a sporting event, scores of the sporting event, and result of the sporting event cannot be obtained from a single source. Thus, it is difficult of obtaining such information as a whole for sports fans. It is very inconvenient. Further, sports fans cannot get real time information about more than one sporting event being played at different venues at the same time or at the same venue.

Thus, the need for improvement still exists.

### SUMMARY OF THE INVENTION

It is therefore one object of the invention to provide a method of providing sporting event services over the Internet, the method comprising the steps of providing a sports portal comprising a sporting event registration module so that each of a plurality of members is allowed to file with the sporting event registration module by loading data including bibliographical data into the sporting event registration module for storage; providing a transmitter and a verification code to each member wherein the verification code is unique to the transmitter; electrically connecting a receiver to the sports portal wherein the receiver receives signals transmitted from the transmitter; causing the sports portal to verify the verification code by comparing the verification code with data stored in the sporting event registration module; finishing a registration if the verification is positive; and sending the registration to the sports portal.

In a first aspect of the invention, further comprises the step (g) of starting a sporting event wherein scores of the ongoing sporting event is being refreshed every a predetermined period of time and sent to the sports portal.

In a second aspect of the invention, further comprises the step (h) of causing the sports portal to show latest scores and a final result at an end of the sporting event.

In a third aspect of the invention, the sports portal further comprises a shopping module so that after step (f), any member is allowed to buy products displayed on the shopping module in a discount.

In a fourth aspect of the invention, the sports portal further comprises a sports curriculum module for the members.

In a fifth aspect of the invention, the sports portal further comprises a sports center and news module for providing latest sports news and allowing the members to discuss sport-related articles on the sports portal.

In a sixth aspect of the invention, either the transmitter transmits signals in the range of wavelengths of infrared (IR) light, and correspondingly the receiver receives the IR signals transmitted from the transmitter; or the transmitter transmits signals in the range of wavelengths of radio frequency (RF), and correspondingly the receiver receives the RF signals transmitted from the transmitter.

In a seventh aspect of the invention, the transmitter is disposed on a wrist ring.

The above and other objects, features and advantages of the invention will become apparent from the following detailed description taken with the accompanying drawings.

### BRIEF DESCRIPTION OF THE DRAWINGS

FIG. 1 schematically depicts a system of providing online sporting event services according to the invention; and

FIG. 2 is a flow chart illustrating a method of providing online sporting event services according to the invention.

### DETAILED DESCRIPTION OF THE INVENTION

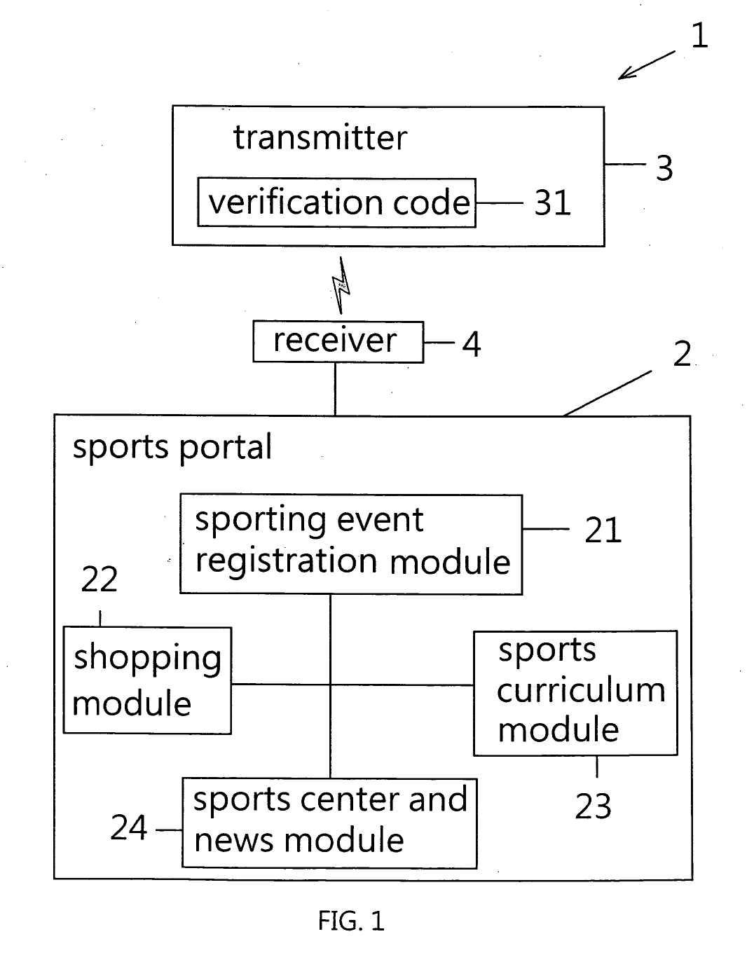

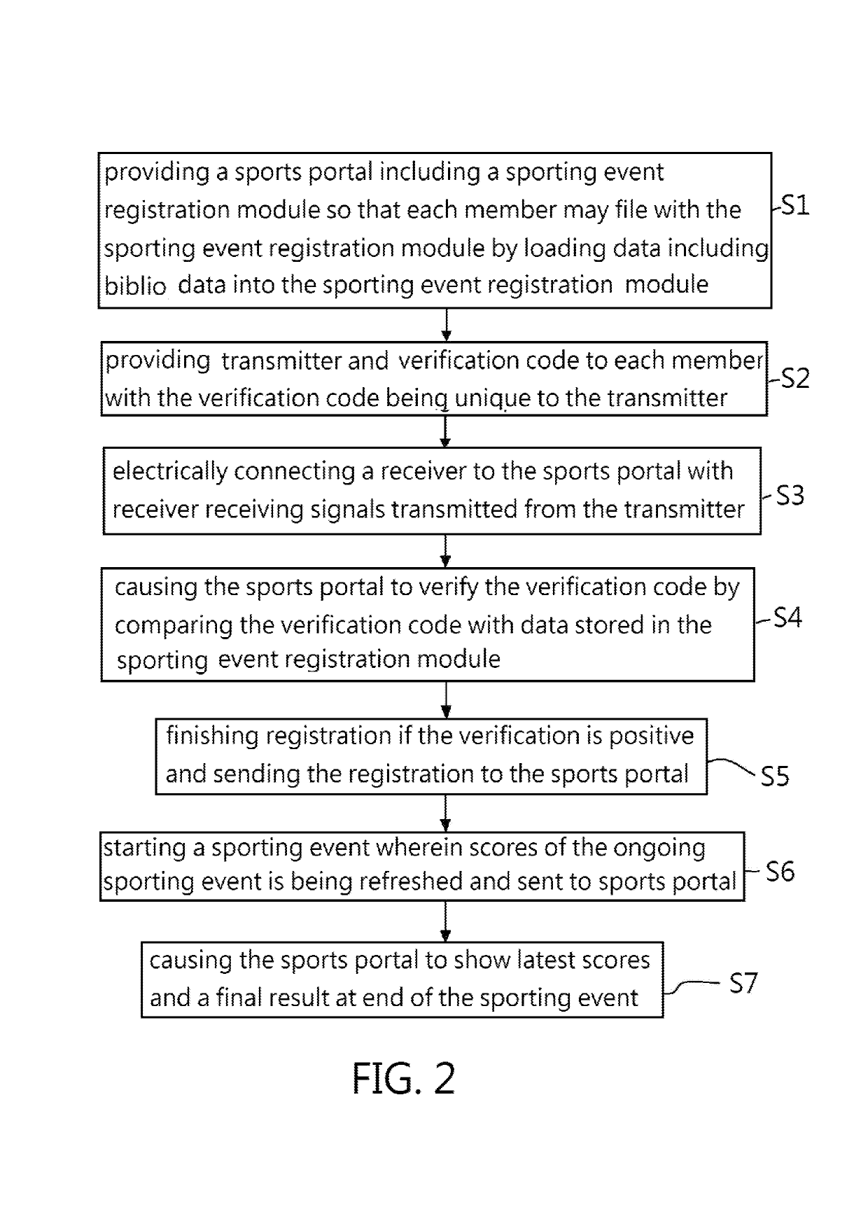

Referring to FIGS. 1 and 2, a method of providing online sporting event services in accordance with the invention is illustrated in conjunction with the description of a system 1 of providing online sporting event services in FIG. 1. The method comprises the following steps:

Step S1: Providing a sports portal 2 over the Internet. The sports portal 2 comprises a sporting event registration module 21. Any member may fill a form and send the form to the sporting event registration module 21 for registration. Data including bibliographical data of the form will be loaded directly into a memory of the sporting event registration module 21 for storage.

Step S2: Providing a transmitter 3 and a verification code 31 to each member in which the verification code 31 is unique to the transmitter 3.

Step S3: Providing a receiver 4 which is electrically connected to the sports portal 2. The receiver 4 can receive signals transmitted from the transmitter 3 (i.e., wireless communication).

Step S4: Causing the sports portal 2 to verify the verification code 31 by comparing the verification code 31 with member records.

Step S5: Finishing a registration if the verification is positive. Further, the registration is sent to the sports portal 2.

Step S6: Starting a sporting event (e.g., marathon as an exemplary example) in which scores or time data of the ongoing marathon is being refreshed every a predetermined period of time and sent to the sports portal 2.

Step S7: Causing the sports portal 2 to show the latest scores or time data and a final result at an end of the marathon. Thus, any member can know the latest scores and result by accessing the sports portal 2 over the Internet.

Preferably, the transmitter 3 can transmit signals in the range of wavelengths of infrared (IR) light. Correspondingly, the receiver 4 can receive the IR signals transmitted from the transmitter 3. Alternatively, the transmitter 3 is a radio frequency identification (RFID) transmitter 3 and correspondingly, the receiver 4 is an RFID receiver 4.

Preferably, the transmitter 3 is provided on a wrist ring worn on the hand of a member so that the members may participate the sporting event in a convenient way.

Preferably, the sports portal 2 further comprises a shopping module 22 so that after a successful registration, any member may view products displayed on the shopping module 22 and buy the same. Preferably, the member having registered a sporting event can buy the products in a special discount and other members not registered with any sporting event can buy the same products at an ordinary discount which is higher than the special account in terms of money.

Preferably, the discount can be classified as two in which one discount is a platinum discount for platinum members (i.e., highest discount) and the other discount is for ordinary members (i.e., discount lower than the highest discount). Further, bonus may be given to a registered platinum member to participate a sporting event. Furthermore, group members may be given a different discount other than above.

Preferably, the sports portal 2 further comprises a sports curriculum module 23 for members.

Preferably, the sports portal 2 further comprises a sports center and news module 24 for providing latest sports news and allowing members to discuss sport-related articles on the sports portal 2.

While the invention has been described in terms of preferred embodiments, those skilled in the art will recognize that the invention can be practiced with modifications within the spirit and scope of the appended claims.

What is claimed is:

1. A method of providing sporting event services over the Internet, the method comprising the steps of:
(a) providing a sports portal comprising a sporting event registration module so that each of a plurality of members is allowed to file with the sporting event registration module by loading data including bibliographical data into the sporting event registration module for storage;
(b) providing a transmitter and a verification code to each member wherein the verification code is unique to the transmitter;
(c) electrically connecting a receiver to the sports portal wherein the receiver receives signals transmitted from the transmitter;
(d) causing the sports portal to verify the verification code by comparing the verification code with data stored in the sporting event registration module;
(e) finishing a registration if the verification is positive; and
(f) sending the registration to the sports portal.

2. The method of claim 1, further comprising the step (g) of starting a sporting event wherein scores of the ongoing sporting event is being refreshed every a predetermined period of time and sent to the sports portal.

3. The method of claim 2, further comprising the step (h) of causing the sports portal to show latest scores and a final result at an end of the sporting event.

4. The method of claim 1, wherein the sports portal further comprises a shopping module so that after step (f), any member is allowed to buy products displayed on the shopping module in a discount.

5. The method of claim 1, wherein the sports portal further comprises a sports curriculum module for the members.

6. The method of claim 1, wherein the sports portal further comprises a sports center and news module for providing latest sports news and allowing the members to discuss sport-related articles on the sports portal.

7. The method of claim 1, wherein either the transmitter transmits signals in the range of wavelengths of infrared (IR) light, and correspondingly the receiver receives the IR signals transmitted from the transmitter; or the transmitter transmits signals in the range of wavelengths of radio frequency (RF), and correspondingly the receiver receives the RF signals transmitted from the transmitter.

8. The method of claim 1, wherein the transmitter is disposed on a wrist ring.
